(19) United States
(12) Patent Application Publication
(10) Pub. No.: US 2023/0309586 A1
(43) Pub. Date: Oct. 5, 2023

(54) METHOD FOR IMPROVING COOKED RICE FOOD PRODUCTS

(71) Applicant: AJINOMOTO CO., INC., Tokyo (JP)

(72) Inventors: Kei NAKAJIMA, Kawasaki-shi (JP); Takahiro ITO, Kawasaki-shi (JP); Wakako OOHASHI, Kawasaki-shi (JP)

(73) Assignee: AJINOMOTO CO., INC., Tokyo (JP)

(21) Appl. No.: 18/329,951

(22) Filed: Jun. 6, 2023

Related U.S. Application Data
(63) Continuation of application No. PCT/JP2021/045811, filed on Dec. 13, 2021.

(30) Foreign Application Priority Data
Dec. 14, 2020 (JP) 2020-206446

(51) Int. Cl. A23L 7/104; A23L 7/10

(52) U.S. Cl. CPC A23L 7/107; A23L 7/1975

(57) ABSTRACT

Provided is a technique for improving a cooked-rice food product. A cooked-rice food product is improved by using the following component (A): (A) Bacillus licheniformis-derived α-amylase.

### TECHNICAL FIELD

The present invention relates to a technique for improving a cooked-rice food product.

### BACKGROUND ART

When raw rice is heated (i.e., cooked) in the presence of moisture, alpha conversion (i.e., gelatinization) of rice takes place, and the rice becomes a form suitable for human ingestion. However, scorching cooked rice to a rice cooker can be a problem during rice cooking. In addition, after the rice is cooked, the rice undergoes β-conversion (aging) over time, and the taste may deteriorate. Therefore, techniques have been developed to improve the quality of a cooked-rice food product, such as the suppression of scorching or aging of cooked rice and the like.

Known techniques for improving the quality of cooked rice include a method for preventing scorching of cooked rice by using α-amylase and protease (Patent Literature 1), a method for preventing the aging of cooked rice by using α-amylase (Patent Literature 2), and a method for improving cooked rice by using an enzyme such as α-amylase (Patent Literature 3).

### CITATION LIST

### Patent Literature

Patent Literature 1: Japanese Laid-Open Patent Publication No. 2005-341942
Patent Literature 2: Japanese Laid-Open Patent Publication No. 7-289186 (1995)
Patent Literature 3: Japanese Laid-Open Patent Publication No. 2004-290075

### SUMMARY OF INVENTION

### Technical Problem

An object of the present invention is to provide a technique for improving a cooked-rice food product.

### Solution to Problem

The present inventors have found that a cooked-rice food product can be successfully improved by cooking rice in the presence of Bacillus licheniformis-derived α-amylase. This has led to the completion of the present invention.

In other words, the present invention can be exemplified as follows.

[1] A composition,
which is for producing or improving a cooked-rice food product, and
which contains the following component (A):
   (A) Bacillus licheniformis-derived α-amylase.
   [2] The above-described composition, wherein the improvement is suppressing scorching and/or aging of the cooked-rice food product.
   [3] The above-described composition, which further contains the following component (B):
   (B) a glycosyltransferase.
   [4] The above-described composition, wherein the glycosyltransferase is maltotriosyl transferase.
   [5] A method for producing a cooked-rice food product, comprising
a step of treating a cooked-rice food product ingredient with the following component (A):
   (A) Bacillus licheniformis-derived α-amylase.
   [6] The above-described method, wherein the produced cooked-rice food product is an improved cooked-rice food product.
   [7] A method for improving a cooked-rice food product, comprising a step of treating a cooked-rice food product ingredient with the following component (A):
   (A) Bacillus licheniformis-derived α-amylase.
   [8] The above-described method, wherein the improvement is suppressing scorching and/or aging of the cooked-rice food product.
   [9] The above-described method, wherein the treatment is performed during rice cooking.
   [10] The above-described method, wherein the component (A) is added in an amount of from 0.001 to 10 U per 1 g of raw rice.
   [11] The above-described method, which further comprises a step of treating the cooked-rice food product ingredient with the following component (B):
   (B) a glycosyltransferase.
   [12] The above-described method, wherein the glycosyltransferase is maltotriosyl transferase.
   [13] An agent for improving or producing a cooked-rice food product, which contains the following component (A):
   (A) Bacillus licheniformis-derived α-amylase.
   [14] The above-described agent, wherein the improvement is suppressing scorching and/or aging of the cooked-rice food product.
   [15] The above-described agent, which further contains the following component (B):
   (B) a glycosyltransferase.
   [16] The above-described agent, wherein the glycosyltransferase is maltotriosyl transferase.

### BRIEF DESCRIPTION OF DRAWINGS

FIG. 1 is a diagram (photograph) showing the effect of improving cooked rice (colored rice) by Bacillus licheniformis-derived α-amylase.

FIG. 2 is a diagram (photograph) showing the effect of improving cooked rice (white rice) by Bacillus licheniformis-derived α-amylase.

### DESCRIPTION OF EMBODIMENTS

### <1> Active Substance

In the present invention, the following component (A) is used as an active substance:

(A) Bacillus licheniformis-derived α-amylase.

In other words, the above-described component (A) is also referred to as an “active substance.”

A cooked-rice food product can be improved by using the active substance; that is to say, the effect of improving a cooked-rice food product can be obtained. This effect is also referred to as an “effect of improving a cooked-rice food product.” In other words, a cooked-rice food product can be improved by using the active substance, compared with a case in which the active substance is not used. Therefore, the active substance can be used for improving a cooked-rice food product.

In addition, as a result of improving a cooked-rice food product, an improved cooked-rice food product can be obtained. In other words, an improved cooked-rice food product can be produced by using the active substance. In other words, an improved cooked-rice food product can be produced by using the active substance, compared with a case in which the active substance is not used. Therefore, the active substance may be used for producing a cooked-rice food product (specifically, producing an improved cooked-rice food product). The expressions “improving a cooked-rice food product” and “producing an improved cooked-rice food product” can be used interchangeably.

It is favorable that a high effect of improving a cooked-rice food product can be obtained by using the active substance, particularly compared with a case in which α-amylase derived from an organism other than Bacillus licheniformis. Examples of an organism other than Bacillus licheniformis include Bacillus amyloliquefaciens, Bacillus subtilis, and Aspergillus oryzae.

The active substance may be used for improving or producing a cooked-rice food product in an aspect described later for the method of the present invention.

Examples of improving a cooked-rice food product include suppressing the scorching of a cooked-rice food product and suppressing the aging of a cooked-rice food product. The aging of a cooked-rice food product is also referred to as the “deterioration of a cooked-rice food product.” A particular example of improving a cooked-rice food product is suppressing the scorching of a cooked-rice food product. Examples of the scorching of a cooked-rice food product include the scorching of a cooked-rice food product when producing a cooked-rice food product (e.g., during rice cooking). Examples of the scorching of a cooked-rice food product when producing a cooked-rice food product (e.g., during rice cooking) include the scorching occurring on a contact surface between a cooked-rice food product and a cooking device (e.g., a rice cooker) when producing a cooked-rice food product (e.g., during rice cooking). Examples of the aging of a cooked-rice food product include the aging of a cooked-rice food product after producing a cooked-rice food product (e.g., after rice cooking). Examples of the aging of a cooked-rice food product after producing a cooked-rice food product (e.g., after rice cooking) include the aging of a cooked-rice food product with the elapse of time after producing a cooked-rice food product (e.g., after rice cooking). The temperature over time after producing a cooked-rice food product (e.g., after rice cooking) is not particularly limited. Examples of the temperature over time after producing a cooked-rice food product (e.g., after rice cooking) may be, for example, freezing temperature, refrigerating temperature, room temperature, heat-retention temperature, heating temperature, or a temperature corresponding to a combination thereof. The temperature over time after producing a cooked-rice food product (e.g., after rice cooking) may be, for example, −20° C. or more, −10° C. or more, 0° C. or more, 10° C. or more, 20° C. or more, 30° C. or more, 40° C. or more, 50° C. or more, 60° C. or more, 70° C. or more, 80° C. or more, or 90° C. or more, and also 100° C. or less, 90° C. or less, 80° C. or less, 70° C. or less, 60° C. or less, 50° C. or less, 40° C. or less, 30° C. or less, 20° C. or less, 10° C. or less, 0° C. or less, or −10° C. or less, or a non-contradictory combination thereof. The length of time after producing a cooked-rice food product (e.g., after rice cooking) may be, for example, 1 hour or more, 2 hours or more, 3 hours or more, 6 hours or more, 12 hours or more, 18 hours or more, or 24 hours or more, and also 60 hours or less, 48 hours or less, 36 hours or less, 24 hours or less, 18 hours or less, 12 hours or less, or 6 hours or less, or a non-contradictory combination thereof. Specific examples of the aging of a cooked-rice food product include reduced softness of a cooked-rice food product and reduced elasticity of a cooked-rice food product. Whether a cooked-rice food product has been improved can be confirmed by, for example, comparing a target improvement parameter (e.g., the scorching or aging of a cooked-rice food product) between a cooked-rice food product that has been produced by using the active substance and a cooked-rice food product that has been produced without using the active substance. A method for measuring a target improvement parameter can be selected as appropriate depending on conditions such as the parameter type. The scorching of a cooked-rice food product can be measured by, for example, visually confirming the degree of scorching of a cooked-rice food product. For example, the degree of scorching can be determined by employing the color or area of scorching as an index. In other words, for example, in a case in which the scorching color of a cooked-rice food product that has been produced by using the active substance is lighter than the scorching color of a cooked-rice food product that has been produced without using the active substance, it can be judged that the scorching of a cooked-rice food product is suppressed. In addition, for example, in a case in which the scorching area of a cooked-rice food product that has been produced by using the active substance is smaller than the scorching area of a cooked-rice food product that has been produced without using the active substance, it can be judged that the scorching of a cooked-rice food product is suppressed. The aging of a cooked-rice food product can be measured by, for example, sensory evaluation by a specialized panel. The aging of a cooked-rice food product may be measured as, for example, the aging of a cooked-rice food product with the elapse of time after producing a cooked-rice food product (e.g., after rice cooking) under any of the above-exemplified conditions. In other words, the aging of a cooked-rice food product may be measured as, for example, the aging of a cooked-rice food product when storing a cooked-rice food product at 20° C. for 30 hours after producing a cooked-rice food product (e.g., after rice cooking).

In other words, the improvement of a cooked-rice food product may be achieved by improving a cooked rice portion that constitutes a cooked-rice food product. Therefore, specifically, the expression “improvement of a cooked-rice food product” may refer to the improvement of a cooked rice portion that constitutes a cooked-rice food product. In addition, specifically, the term “cooked-rice food product” mentioned in the expression “improvement of a cooked-rice food product” may refer to a cooked rice portion that constitutes a cooked-rice food product.

The term “α-amylase” may refer to endoamylase, which is specifically a protein having an activity to catalyze a reaction that randomly cleaves α-1,4-glycosidic linkages of an α-1,4-D-glucan chain (e.g., EC 3.2.1.1). This activity is also referred to as “α-amylase activity.” Examples of α-amylase include liquefied α-amylase and glycated α-amylase. For liquefied α-amylase, in particular, the α-1,4-D-glucan chain may be crudely cleaved to produce a high-molecular-weight product preferentially. For glycated α-amylase, in particular, the α-1,4-D-glucan chain may be finely cleaved to produce a low-molecular-weight product such as glucose or maltose preferentially.

The term “Bacillus licheniformis-derived α-amylase” refers to α-amylase derived from Bacillus licheniformis. The “α-amylase derived from Bacillus licheniformis” is not limited to a case in which the α-amylase is α-amylase found in Bacillus licheniformis but also encompasses a case in which the α-amylase is an artificial variant of α-amylase found in Bacillus licheniformis. The artificial variant is not particularly limited as long as it has a desired α-amylase activity. Bacillus licheniformis-derived α-amylase may be, for example, one obtained through production in Bacillus licheniformis or one obtained through heterologous expression (i.e., recombinant enzyme). Examples of Bacillus licheniformis-derived α-amylase that can be used include a commercially available product and those obtained through appropriate production. Examples of a commercially available product of Bacillus licheniformis-derived α-amylase include Kokugen SD-T (Amano Enzyme Inc.).

Bacillus licheniformis-derived α-amylase may or may not contain a component other than Bacillus licheniformis-derived α-amylase. Bacillus licheniformis-derived α-amylase may contain, for example, a different enzyme. In other words, purified Bacillus licheniformis-derived α-amylase or a material containing Bacillus licheniformis-derived α-amylase may be used as Bacillus licheniformis-derived α-amylase. Examples of a material containing Bacillus licheniformis-derived α-amylase include a culture of a microorganism that produces Bacillus licheniformis-derived α-amylase, a culture supernatant isolated from the culture, a bacterial cell isolated from the culture, and a treated product of the bacterial cell. Bacillus licheniformis-derived α-amylase may be purified to a desired extent.

The activity of α-amylase can be measured according to the following procedure. In other words, the activity of α-amylase can be determined by incubating the enzyme with a substrate and measuring enzyme-dependent substrate degradation. The substrate degradation can be measured by, for example, using the generation of a reducing end (i.e., an increase in reducing power) as an index. An increase in reducing power can be measured by, for example, the dinitrosalicylic acid (DNS) method or the Nelson-Somogyi method. Using a 1.3% soluble starch solution as a substrate, 1 U (unit) is defined as the amount of an enzyme that decomposes 1 μmol of a substrate (i.e., generates 1 μmol of a reducing end) per minute at 40° C. and pH 6.0.

### <2> Composition of the Present Invention

The composition of the present invention is a composition which contains an active substance.

In other words, the composition of the present invention is a composition which contains the following component (A):

(A) Bacillus licheniformis-derived α-amylase.

A cooked-rice food product can be improved by using the composition of the present invention. In other words, the effect of improving a cooked-rice food product can be obtained by using the composition of the present invention. Accordingly, the composition of the present invention may be used for improving a cooked-rice food product. In other words, the composition of the present invention may be, for example, a composition for improving a cooked-rice food product. In addition, the composition of the present invention may be, for example, an agent for improving a cooked-rice food product (i.e., an agent intended for improving a cooked-rice food product).

In addition, an improved cooked-rice food product can be produced by using the composition of the present invention. Therefore, the composition of the present invention may be used for producing a cooked-rice food product (specifically, producing an improved cooked-rice food product). In other words, the composition of the present invention may be, for example, a composition for producing a cooked-rice food product (specifically, producing an improved cooked-rice food product). In addition, the composition of the present invention may be, for example, an agent for producing a cooked-rice food product (i.e., an agent intended for producing a cooked-rice food product).

The composition of the present invention may be used for improving or producing a cooked-rice food product in an aspect described later for the method of the present invention.

The composition of the present invention may or may not consist of the active substance. In other words, the composition of the present invention may contain a component other than the active substance. A composition consisting of the active substance may be excluded from the composition of the present invention.

A component other than the active substance is not particularly limited unless the effect of improving a cooked-rice food product is impaired. A component other than the active substance can be selected depending on, for example, conditions such as the type of a cooked-rice food product ingredient and the type of a cooked-rice food product, if appropriate. Examples of a component other than the active substance include a component blended in a food product or a pharmaceutical product.

Specific examples of a component other than the active substance include glycosyltransferase and hemicellulase. Glycosyltransferase and hemicellulase can be effective for, for example, suppressing the aging of a cooked-rice food product. Hemicellulase can be effective for, for example, suppressing dryness on a surface of a cooked-rice food product (specifically, a surface of cooked rice contained in the cooked-rice food product). Examples of dryness on a surface of a cooked-rice food product include dryness on a surface of a cooked-rice food product (e.g., a chilled cooked-rice food product) due to overheating during heating (e.g., heating with a microwave) of the surface of a cooked-rice food product.

The term “glycosyltransferase” may refer to a protein having an activity to catalyze transglycosylation. Examples of glycosyltransferase include maltotriosyl transferase (MTT), branching enzyme, and transglucosidase. The term “maltotriosyl transferase” may refer to a protein having an activity to catalyze a reaction in which a maltotriose unit is cleaved from an α-1,4-D-glucan chain and transferred to a different α-1,4-D-glucan chain. The transfer of the maltotriose unit may occur intramolecularly, intermolecularly, or both. The term “branching enzyme” may refer to a protein having an activity to catalyze a reaction in which a sugar chain is cleaved from an α-1,4-D-glucan chain and transferred to the 6-OH group of a different α-1,4-D-glucan chain to form a branched structure of α-1,6-glycosidic bonds (e.g., EC 2.4.1.18). The transfer of the sugar chain may occur intramolecularly, intermolecularly, or both. The term “transglucosidase” may refer to a protein having an activity to catalyze a reaction in which a glucose unit is cleaved from the non-reducing end of an α-1,4-D-glucan chain and transferred to the 6-OH group of the α-1,4-D-glucan chain to form a branched structure of α-1,6-glycosidic bonds (e.g., EC 3.2.1.2). The transfer of the glucose unit may occur intramolecularly, intermolecularly, or both.

The origin of glycosyltransferase is not particularly limited. Glycosyltransferase may be derived from any of microorganisms, animals, plants, and the like. In addition, a known homolog of glycosyltransferase may be used as glycosyltransferase. An artificial variant of known glycosyltransferase or a homolog thereof may also be used as glycosyltransferase. Glycosyltransferase may be, for example, one obtained through heterologous expression (i.e., recombinant enzyme). Examples of glycosyltransferase that can be used include a commercially available product and those obtained through appropriate production. Examples of commercially available maltotriosyl transferase include Glyco Transferase “Amano” (Amano Enzyme Inc.). Examples of commercially available branching enzyme include Branching Enzyme A (Nagase & Co., Ltd.). Examples of commercially available transglucosidase include Transglucosidase L “Amano” (Amano Enzyme Inc.).

Glycosyltransferase may or may not contain a component other than glycosyltransferase. Glycosyltransferase may contain, for example, another enzyme. In other words, purified glycosyltransferase or a material containing glycosyltransferase may be used as glycosyltransferase. Examples of a material containing glycosyltransferase include a culture of a microorganism that produces glycosyltransferase, a culture supernatant isolated from the culture, a bacterial cell isolated from the culture, and a treated product of the bacterial cell. Glycosyltransferase may be purified to a desired extent. One type of glycosyltransferase or a combination of two or more types of glycosyltransferase may be used as glycosyltransferase.

The activity of glycosyltransferase can be measured according to the following procedure. In other words, the activity of glycosyltransferase can be determined by incubating the enzyme with a substrate and measuring enzyme-dependent sugar chain transfer.

For example, the activity of maltotriosyl transferase can be measured according to the following procedure. In other words, for the activity of maltotriosyl transferase, the glucose production is quantitatively determined after a reaction at 40° C. for 60 minutes with the addition of 0.5 mL of an enzyme solution to 2 mL of a substrate solution (10 mmol/L MES buffer (pH 6.5) containing 1% Maltotetraose (manufactured by Hayashibara Biochemical Laboratories, Inc.)). The glucose production can be determined with, for example, Glucose CII-Test Wako (Wako Pure Chemical Industries, Ltd.). The amount of enzyme that produces 1 μmol of glucose in 2.5 mL of the reaction solution per minute in this reaction system is defined as 1 U (unit).

For example, the activity of branching enzyme can be measured according to the following procedure. In other words, for the activity of branching enzyme, a reaction is carried out at 50° C. for 30 minutes by adding 50 μL of an enzyme solution (0.1 M phosphate buffer (pH 7.0) containing an enzyme) to 50 μL of a substrate solution (0.08 M phosphate buffer (pH 7.0) containing 0.1% Amylose B (NACALAI TESQUE, INC.)), after which 2 mL of an iodine reagent (a solution prepared by mixing 0.5 mL of a solution in which 0.26 g of I₂ and 2.6 g of KI are dissolved in 10 mL of ultrapure water and 0.5 mL of 1 N HCl and diluting the mixture to 130 mL) is added to measure the absorbance at 660 nm. The amount of enzyme that reduces the absorbance at 660 nm by 1% per minute in this reaction system is defined as 1 U (unit).

The term “hemicellulase” may refer to a protein having an activity to catalyze the hydrolysis reaction of hemicellulose. The term “hemicellulose” may refer to a polysaccharide constituting plant cell walls other than cellulose and pectin. Examples of hemicellulose include xylan, mannan, and complex polysaccharides containing them (arabinoxylan, glucuronoxylan, glucomannan, and the like). Examples of hemicellulase include xylanase and mannanase. Particular examples of hemicellulase include xylanase. The term “xylanase” may refer to a protein having an activity to catalyze the hydrolysis reaction of xylan or a complex polysaccharide containing it (arabinoxylan, glucuronoxylan, or the like). The term “mannanase” may refer to a protein having an activity to catalyze the hydrolysis reaction of mannan or a complex polysaccharide containing it (glucomannan or the like).

The origin of hemicellulase is not particularly limited. Hemicellulase may be derived from any of microorganisms, animals, plants, and the like. In addition, a known hemicellulase homolog may be used as hemicellulase. An artificial variant of known hemicellulase or a homolog thereof may also be used as hemicellulase. Hemicellulase may be, for example, one obtained through heterologous expression (i.e., recombinant enzyme). Examples of hemicellulase that can be used include a commercially available product and those obtained through appropriate production. Examples of commercially available hemicellulase include hemicellulase “Amano” 90 (Amano Enzyme Inc.) and Sumizyme X (SHINNIHON CHEMICALS Corporation).

Hemicellulase may or may not contain a component other than hemicellulase. Hemicellulase may contain, for example, another enzyme. In other words, purified hemicellulase or a material containing hemicellulase may be used as hemicellulase. Examples of a material containing hemicellulase include a culture of a microorganism that produces hemicellulase, a culture supernatant isolated from the culture, a bacterial cell isolated from the culture, and a treated product of the bacterial cell. Hemicellulase may be purified to a desired extent. One type of hemicellulase or a combination of two or more types of hemicellulase may be used as hemicellulase.

The activity of hemicellulase can be measured according to the following procedure. In other words, the activity of hemicellulase can be determined by incubating the enzyme with a substrate and measuring enzyme-dependent substrate degradation. The substrate degradation can be measured by, for example, using the generation of a reducing sugar (i.e., an increase in reducing power) as an index.

For example, the activity of hemicellulase (e.g., xylanase) can be measured according to the following procedure. In other words, for the activity of hemicellulase (e.g., xylanase), a 10 mg/mL hemicellulose solution (e.g., 10 mg/mL xylan solution) is used as a substrate, and 1 mL of an enzyme solution is added to 1 mL of the substrate and 3 mL of 0.1 mol/L acetic acid-sodium acetate buffer (pH 4.5) to carry out a reaction at 40° C. for 30 minutes. Then, 2 mL of Somogyi reagent is added, the mixture is heated in a boiling water bath for 20 minutes and then cooled, 1 mL of Nelson's solution is added, mixing is performed until the cuprous oxide precipitate is completely dissolved, and water is added to make up to 25 mL. After centrifugation, the change in absorbance at 500 nm is measured, and the amount of reducing sugar produced is calculated. The amount of an enzyme that produces a reducing sugar equivalent to 1 mg of xylose per minute in this reaction system is defined as 100 U (unit).

Specific examples of a component other than the active substance include a component effective for producing a cooked-rice food product. Examples of a component effective for producing a cooked-rice food product include a cooked-rice food product ingredient as described later.

One type of component or a combination of two or more types of components may be used as a component other than the active substance.

The composition of the present invention can be produced by, for example, mixing the active substance and, optionally, another component, if appropriate.

The composition of the present invention may be, for example, formulated, if appropriate. An additive may be used for formulation, if appropriate. Examples of the additive include an excipient, a binder, a disintegrant, a lubricant, a stabilizer, a flavoring agent, a diluent, a surfactant, and a solvent. An additive can be selected depending on conditions such as the shape of the composition of the present invention, if appropriate.

The shape of the composition of the present invention is not particularly limited. The composition of the present invention may be in any shape, for example, a powder, flakes, tablets, paste, liquid, or the like.

The content of the individual component (i e , the active substance and, optionally, another component) in the composition of the present invention are not particularly limited as long as the effect of improving the cooked-rice food product can be obtained. The content of the individual component in the composition of the present invention can be set as appropriate depending on condition such as the type of component, the amount of the individual component used for improving or producing a cooked-rice food product, and the amount of the composition of the present invention for improving or producing a cooked-rice food product.

The content of the active substance in the composition of the present invention is more than 0% (w/w) and 100% (w/w) or less. The content of the active substance in the composition of the present invention may be, for example, 0.001% (w/w) or more, 0.01% (w/w) or more, 0.1% (w/w) or more, 1% (w/w) or more, or 10% (w/w) or more, and also 100% (w/w) or less, 99.9% (w/w) or less, 50% (w/w) or less, 10% (w/w) or less, or 1% (w/w) or less, or a non-contradictory combination thereof.

In addition, the content of the active substance in the composition of the present invention may be, for example, 0.005 U or more, 0.01 U or more, 0.02 U or more, 0.05 U or more, 0.1 U or more, 0.2 U or more, 0.5 U or more, 1 U or more, 1.5 U or more, 2 U or more, 2.5 U or more, 3.5 U or more, 5 U or more, 10 U or more, 25 U or more, 50 U or more, 100 U or more, 200 U or more, or 500 U or more, and also 50000 U or less, 20000 U or less, 10000 U or less, 5000 U or less, 2500 U or less, 1000 U or less, 500 U or less, 250 U or less, 100 U or less, 50 U or less, 25 U or less, 10 U or less, 5 U or less, 2 U or less, 1 U or less, or 0.5 U or less per 1 g of the composition of the present invention, or a non-contradictory combination thereof. In other words, the content of the active substance in the composition of the present invention may be, for example, from 0.05 to 50000 U, from 0.5 to 5000 U, from 1 to 500 U, or from 1.5 to 50 U per 1 g of the composition of the present invention.

In addition, the content of the individual component (i.e., the active substance and, optionally, another component) in the composition of the present invention can be set such that, for example, the amount of each component added is within a desired range when improving or producing a cooked-rice food product by using the composition of the present invention. The amount of each component added may be, for example, in a range exemplified in the description (below) of the method of the present invention.

The individual component (i.e., the active substance and, optionally, another component) contained in the composition of the present invention may be mixed with each other to be contained in the composition of the present invention or may be contained separately or separately in optional combinations thereof in the composition of the present invention. For example, the composition of the present invention may be provided as a set of separately packaged components. In such a case, the components included in the set can be combined when used, if appropriate.

### <3> Method of the Present Invention

The method of the present invention comprises a step of using an active sub stance.

In other words, the method of the present invention comprises a step of using the following component (A):

(A) Bacillus licheniformis-derived α-amylase.

According to the method of the present invention, specifically, a cooked-rice food product can be improved by using an active substance; that is to say, the effect of improving a cooked-rice food product can be obtained. Therefore, the method of the present invention may be carried out for improving a cooked-rice food product. In other words, the method of the present invention may be, for example, a method for improving a cooked-rice food product. This method is also referred to as the “improvement method of the present invention.”

In addition, according to the method of the present invention, specifically, by using the active substance, an improved cooked-rice food product can be produced. Therefore, the method of the present invention may be carried out for producing a cooked-rice food product (specifically, producing an improved cooked-rice food product). In other words, the method of the present invention may be, for example, a method for producing a cooked-rice food product (specifically, producing an improved cooked-rice food product). This method is also referred to as the “production method of the present invention.”

In improving or producing a cooked-rice food product, the active substance can be used for treating a cooked-rice food product ingredient. In other words, examples of the use of the active substance include treating a cooked-rice food product ingredient with the active substance. In other words, the method of the present invention may be, for example, a method for improving a cooked-rice food product comprising a step of treating a cooked-rice food product ingredient with an active substance. In addition, the method of the present invention may also be, for example, a method for producing a cooked-rice food product (specifically, an improved cooked-rice food product) comprising a step of treating a cooked-rice food product ingredient with an active substance. Note that “treating a cooked-rice food product ingredient with an active substance” is also expressed as “allowing an active substance to act on a cooked-rice food product ingredient.” In addition, the step of “treating a cooked-rice food product ingredient with an active substance” is also referred to as a “treatment step.” In other words, the method of the present invention may comprise the treatment step.

The active ingredient may be used to treat a cooked-rice food product ingredient in any aspect in which the active ingredient can act on a cooked-rice food product ingredient. The active substance may be used in the form of the composition of the present invention to treat a cooked-rice food product ingredient. In other words, “treating a cooked-rice food product ingredient with an active substance” also encompasses treating a cooked-rice food product ingredient with the composition of the present invention.

Improving or producing a cooked-rice food product may be carried out similarly to the usual production of a cooked-rice food product except that, for example, the active substance is used. In other words, improving or producing a cooked-rice food product may be carried out by using the same cooked-rice food product ingredient as for a usual cooked-rice food product and under the same production conditions, except that the active substance is used. In addition, a cooked-rice food product ingredient and production conditions may be altered appropriately for improving or producing a cooked-rice food product. The method of the present invention may comprise a step of producing a cooked-rice food product from a cooked-rice food product ingredient. This step is also referred to as a “step of producing a cooked-rice food product.” In addition, the treatment step may be a step of treating a cooked-rice food product ingredient with an active substance to produce a cooked-rice food product.

The “cooked-rice food product” may mean a food product containing cooked rice. A cooked-rice food product may be produced exclusively from raw rice or may be produced from raw rice and other ingredients. Examples of cooked-rice food products include white rice, red rice, vinegared rice, colored rice, flavored rice, mixed rice, fried rice, pilaf, paella, rice omelet, sticky rice (okowa), risotto, rice gratin, Japanese rice porridge, rice gruel, rice with green tea, rice balls, sushi, curry and rice, rice bowl, and Japanese-style lunch boxes (bento). A cooked-rice food product may be provided in any form, such as a frozen, a chilled, an aseptically packaged, a retort, a dried, or a canned product.

The term “cooked-rice food product ingredient” means a food material for producing a cooked-rice food product. A cooked-rice food product ingredient is not particularly limited as long as a cooked-rice food product can be produced. A cooked-rice food product ingredient can be selected depending on a condition, such as the type of a cooked-rice food product, if appropriate.

At least raw rice is used as a cooked-rice food product ingredient. In other words, a cooked-rice food product ingredient comprises raw rice. In other words, “treating a cooked-rice food product ingredient with an active substance” can mean treating at least raw rice with an active substance. The term “raw rice” can mean rice that has not been heat-treated after harvest. Raw rice is not particularly limited as long as it can be used for producing a cooked-rice food product. For example, an element for specifying raw rice, such as variety, place of production, degree of rice polishing, and storage period, can be selected as appropriate. Raw rice may be either non-glutinous rice or glutinous rice. Raw rice may be, for example, polished rice, rinse-free rice, brown rice, germ rice, or sprouted brown rice. Raw rice may be, for example, newly harvested rice, rice stored for one year, or rice stored for two years. One type of raw rice or a combination of two or more types of raw rice may be used as raw rice.

A cooked-rice food product ingredient may consist of raw rice or may consist of a combination of raw rice and another ingredient. Examples of another ingredient include an ingredient that can be usually used for producing a cooked-rice food product other than raw rice. Specific examples of another ingredient include: food materials such as meat, vegetables, and eggs; seasonings such as sugars, inorganic salts, organic acids, nucleic acids, and amino acids; and fats and oils. One type of ingredient or a combination of two or more types of ingredients may be used as (an)other ingredient(s). For example, another ingredient may be mixed with raw rice in advance, added to raw rice when producing a cooked-rice food product (e.g., during rice cooking), or added to a produced cooked-rice food product (e.g., cooked rice after rice cooking).

The blending amount of another ingredient is not particularly limited as long as a desired cooked-rice food product can be produced. The blending amount of another ingredient can be set depending on, for example, a condition such as the type of a cooked-rice food product ingredient and the type of a cooked-rice food product, if appropriate.

The total blending amount of another ingredient may be, for example, 5 parts by weight or more, 10 parts by weight or more, 20 parts by weight or more, 40 parts by weight or more, 60 parts by weight or more, 80 parts by weight or more, or 100 parts by weight or more, and also 200 parts by weight or less, 150 parts by weight or less, 120 parts by weight or less, 100 parts by weight or less, 80 parts by weight or less, 60 parts by weight or less, 40 parts by weight or less, or 20 parts by weight or less with respect to 100 parts by weight of raw rice, or a non-contradictory combination thereof.

A cooked-rice food product can be produced by, for example, heating a cooked-rice food product ingredient in the presence of moisture. In other words, a cooked-rice food product can be produced by, for example, adding water to a cooked-rice food product ingredient. In other words, the step of producing a cooked-rice food product may comprise, for example, heating a cooked-rice food product ingredient in the presence of moisture. “Heating a cooked-rice food product ingredient in the presence of moisture” means heating at least raw rice in the presence of moisture. Heating raw rice in the presence of moisture is also referred to as “rice cooking.”

The amount of water added is not particularly limited as long as a desired cooked-rice food product can be produced. The amount of water added can be set depending on, for example, conditions such as the type of a cooked-rice food product ingredient and the type of a cooked-rice food product, if appropriate.

The “addition of water” is not limited to a case in which water itself is added, and also encompasses a case in which an ingredient containing moisture is added. In other words, in a case in which an ingredient containing moisture is added, the amount of water added can be reduced depending on the amount of moisture in the ingredient. For example, in a case in which sufficient moisture is supplied to raw rice with the addition of an ingredient containing moisture, water itself does not need to be separately added.

Conditions for performing heating are not particularly limited as long as a desired cooked-rice food product can be produced. Conditions for performing heating can be set depending on, for example, conditions such as the type of a cooked-rice food product ingredient and the type of a cooked-rice food product, if appropriate. Temperature for performing heating may be, for example, a temperature at which a cooked-rice food product ingredient comprising water comes to a boil, which may be specifically about 100° C. Time for performing heating may be, for example, 10 minutes or more, 15 minutes or more, 20 minutes or more, 25 minutes or more, or 30 minutes or more, and also 120 minutes or less, 90 minutes or less, 60 minutes or less, 40 minutes or less, or 30 minutes or less, or a non-contradictory combination thereof. In other words, time for performing heating is, for example, from 10 to 120 minutes, from 15 to 90 minutes, or from 20 to 60 minutes.

The active substance may act on a cooked-rice food product ingredient at any stage of producing a cooked-rice food product as long as the effect of improving a cooked-rice food product can be obtained. The active substance per se or prepared as appropriate in the desired form of a solution or the like is allowed to coexist with a cooked-rice food product ingredient to act on the cooked-rice food product ingredient. For example, the active substance may be added to a cooked-rice food product ingredient or a processed solution containing the active substance may be mixed with a cooked-rice food product ingredient. Such an operation of allowing the active substance to coexist with a cooked-rice food product ingredient is collectively referred to as “adding” the active substance. The active substance may be added, for example, before, at, or after the start of rice cooking. The active substance may be added, for example, before, at, or after the completion of rice cooking. The active substance may be added particularly before the completion of rice cooking. The active substance may be added more particularly before or at the start of rice cooking. In other words, the active substance may be added by the start of rice cooking. In addition, in other words, rice cooking may be started in the presence of the active substance. In a case in which the active substance is added after the start of rice cooking, the active substance may be added by, for example, 30 minutes, 20 minutes, 10 minutes, 5 minutes, 3 minutes, 2 minutes, or 1 minute after the start of rice cooking. In addition, in a case in which the active substance is added after the start of rice cooking, the active substance may be added by, for example, 10 minutes, 20 minutes, 30 minutes, 40 minutes, 50 minutes, or 60 minutes before the completion of rice cooking. In addition, in a case in which the active substance is added after the start of rice cooking, the active substance may be added before, for example, 50%, 40%, 30%, 20%, 10%, or 5% of the time for performing rice cooking has elapsed. Rice cooking may proceed during the treatment of a cooked-rice food product ingredient with the active substance. Therefore, the “cooked-rice food product ingredient” treated with the active substance is not limited to a cooked-rice food product ingredient before the start of rice cooking, and also encompasses a cooked-rice food product ingredient after the start of rice cooking.

Conditions for performing the treatment step are not particularly limited as long as the effect of improving a cooked-rice food product can be obtained. Conditions for performing the treatment step can be set depending on, for example, conditions such as the type of a cooked-rice food product ingredient and the type of a cooked-rice food product, if appropriate. The treatment step may be performed simultaneously when performing the step of producing a cooked-rice food product or may be performed separately from the step of producing a cooked-rice food product. In addition, a part of the treatment step may be performed simultaneously when performing the step of producing a cooked-rice food product and the remaining part thereof may be performed separately from the step of producing a cooked-rice food product. In general, the step of producing a cooked-rice food product may include the treatment step. The treatment step may be performed simultaneously when, for example, performing rice cooking. In other words, the treatment step may be performed during rice cooking. In other words, the treatment step may be, for example, a step of performing rice cooking in the presence of the active substance. Specifically, the treatment step may be a step of heating a cooked-rice food product ingredient (at least raw rice) in the presence of moisture and the active substance. However, depending on conditions, including the timing of adding the active substance, part or whole of the treatment step may be performed before performing the step of producing a cooked-rice food product, or part or whole of the treatment step may be performed after performing the step of producing a cooked-rice food product. For the temperature and time of the treatment step, for example, the descriptions of the temperature and time of performing rice cooking can be applied mutatis mutandis.

The method of the present invention may further comprise a step of using a component other than the active substance. A component other than the active substance is as described above. Specific examples of a component other than the active substance include glycosyltransferase and hemicellulase. Descriptions regarding the use of the active substance can be applied mutatis mutandis to the use of a component other than active substance. In other words, examples of the use of a component other than the active substance include treating a cooked-rice food product ingredient with a component other than the active substance. Descriptions regarding the treatment of a cooked-rice food product ingredient with the active substance can be applied mutatis mutandis to the treatment of a cooked-rice food product ingredient with a component other than the active substance.

The individual component (i.e., the active substance and, optionally, another component) may be simultaneously added to a cooked-rice food product ingredient or may be added separately or separately in optional combinations thereof to a cooked-rice food product ingredient. The order of adding the individual component to a cooked-rice food product ingredient is not particularly limited.

The amounts or ratios of the individual component (i.e., the active substance and, optionally, another component) added in the method of the present invention are not particularly limited as long as the effect of improving a cooked-rice food product can be obtained. The amounts or ratios of the individual component added in the method of the present invention can be set as appropriate depending on conditions such as the types of a cooked-rice food product ingredient or the type of a cooked-rice food product.

The amount of the active substance added may be, for example, 0.0001 U or more, 0.0002 U or more, 0.0005 U or more, 0.001 U or more, 0.002 U or more, 0.003 U or more, 0.004 U or more, 0.005 U or more, 0.007 U or more, 0.01 U or more, 0.02 U or more, 0.05 U or more, or 0.1 U or more, and also 10 U or less, 5 U or less, 2 U or less, 1 U or less, 0.5 U or less, 0.2 U or less, 0.1 U or less, 0.05 U or less, 0.02 U or less, or 0.01 U or less per 1 g of raw rice, or a non-contradictory combination thereof. In other words, the amount of the active substance added may be, for example, from 0.001 to 10 U, from 0.002 to 1 U, or from 0.003 to 0.1 U per 1 g of raw rice.

The amount of glycosyltransferase (e.g., maltotriosyl transferase) added may be, for example, 0.005 U or more, 0.01 U or more, 0.02 U or more, 0.05 U or more, 0.1 U or more, 0.2 U or more, 0.5 U or more, 1 U or more, 2 U or more, 5 U or more, or 10 U or more, and also 500 U or less, 200 U or less, 100 U or less, 50 U or less, 20 U or less, 10 U or less, 5 U or less, 2 U or less, 1 U or less, 0.5 U or less, or 0.2 U or less per 1 g of raw rice, or a non-contradictory combination thereof. In other words, the amount of glycosyltransferase (e.g., maltotriosyl transferase) added may be, for example, from 0.005 to 500 U, from 0.05 to 100 U, or from 0.5 to 20 U per 1 g of raw rice.

The amount of hemicellulase (e.g., xylanase) added may be, for example, 0.00001 U or more, 0.0001 U or more, 0.001 U or more, 0.01 U or more, or 0.1 U or more, and also 10000 U or less, 1000 U or less, 100 U or less, 10 U or less, or 5 U or less per 1 g of raw rice, or a non-contradictory combination thereof. In other words, the amount of hemicellulase (e.g., xylanase) added may be, for example, from 0.00001 to 10000 U, from 0.0001 to 1000 U, or from 0.001 to 100 U per 1 g of raw rice.

Descriptions regarding the treatment of a cooked-rice food product ingredient with the active substance can be applied mutatis mutandis to the treatment of a cooked-rice food product ingredient with the composition of the present invention. For example, the amount of the composition of the present invention used can be set such that the amount of the active substance added as described above can be achieved.

### EXAMPLES

Hereinafter, the present invention will be described in more detail with reference to non-limiting examples.

### Example 1: Evaluation of Effect of Active Substance on Improving Cooked Rice Food Product (1)

In this Example, a cooked rice product (colored rice) was produced by adding an active substance to evaluate the effect of the active substance on improving a cooked-rice food product.

Cooked-rice food product ingredients were mixed according to the formulations shown in Table 1. Rice cooking (heating for 27 minutes and letting rice rest covered for 15 minutes) was carried out using a pot and an induction heater cooktop to produce colored rice products. Scorching of each produced colored rice product was visually confirmed, and the effect of suppressing scorching was evaluated. The evaluation criteria were as follows. In other words, the scorching suppression effect is high in the order of A, B, C, and D, meaning that “A” has the highest effect.

### <Evaluation Criteria for Scorching Suppression Effect>

A: No scorching (The degree of scorching is equivalent to that of the formulation of the Control Sample after heating for 25 minutes.)
B: No scorching but with partial coloring (The degree of scorching is equivalent to that of the formulation of the Control Sample after heating for 26 minutes.)
C: Partial scorching (The degree of scorching is equivalent to that of the formulation of the Control Sample after heating for 26.5 minutes.)
D: Overall scorching (The degree of scorching is equivalent to that of the formulation of the Control Sample (after heating for 27 minutes).)

TABLE 1

| | | Sample with the |
|---|---|---|
| | Control Sample | addition of α-amylase |
| Raw rice (g) | 400 | 400 |
| Water (g) | 530 | 530 |
| Scasoning liquid (g) | 107 | 107 |
| Rice cooking oil (g) | 4 | 4 |
| Bacteriostatic agent (g) | 5.2 | 5.2 |
| α-Amylase (g) | — | As shown in Table 2 |
| MTT (U/g-raw rice) | — | 6.5 |
| α-Glucosidase (U/g-raw rice) | 0.037 | — |

* Enzyme activity valuc (U) is the valuc obtained by the activity measurement method implemented by the manufacturer.
* MTT refers to Glyco Transferase “Amano”

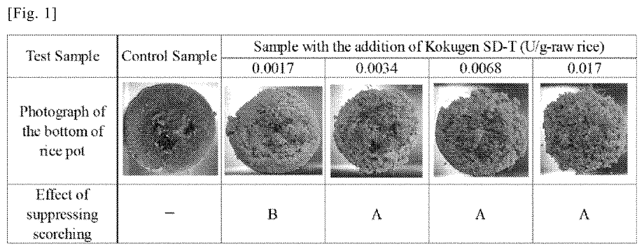

Results are shown in Table 2 and FIG. 1. In the case of adding Bacillus licheniformis-derived α-amylase, scorching suppression was confirmed. On the other hand, in the case of adding α-amylase derived from a different organism, scorching suppression was not confirmed. In particular, in the case of adding Bacillus licheniformis-derived α-amylase in an amount of 0.0034 U/g-raw rice or more, a high scorching suppression effect was confirmed.

TABLE 2

| | | | Effect of |
|---|---|---|---|
| | | Amount added | suppressing |
| α-Amylase | Bacterial origin | (U/g-raw rice) | scorching |
| SPITASE CP-40F | Bacillus | 0.0088 | D |
| | amyloliquefaciens | 0.018 | D |
| | | 0.044 | D |
| | | 0.088 | D |
| | | 0.18 | D |
| Biozyme A | Aspergillus oryzae | 0.020 | D |
| | | 0.050 | D |
| | | 0.10 | D |
| | | 0.20 | D |
| Kokugen SD-A | Bacillus | 0.0024 | D |
| | amyloliquefaciens | 0.024 | D |
| | | 0.12 | D |
| Kokugen SD-T | Bacillus | 0.0017 | B |
| | licheniformis | 0.0034 | A |
| | | 0.0068 | A |
| | | 0.017 | A |

* Enzyme activity value (U) is the value obtained by the activity measurement method implemented by the manufacturer.

### Example 2: Evaluation of Effect of Active Substance on Improving Cooked Rice Food Product (2)

In this Example, a cooked rice product (white rice) was produced by adding an active substance to evaluate the effect of the active substance on improving a cooked-rice food product.

Rice cooking was carried out using a pot and an induction heater cooktop under the conditions shown in Table 3 to produce white rice products. Scorching of each produced white rice product was visually confirmed, and the effect of suppressing scorching was evaluated. The evaluation criteria were as follows. In other words, the scorching suppression effect is high in the order of A, B, C, and D, meaning that “A” has the highest effect.

### <Evaluation Criteria for Scorching Suppression Effect>

A: No scorching (The degree of scorching is equivalent to that of the formulation of Control Sample 1 (after heating for 26 minutes).)
B: No scorching but with partial coloring (The degree of scorching is equivalent to that of the formulation of the Control Sample after heating for 27 minutes.)
C: Partial scorching (The degree of scorching is equivalent to that of the formulation of the Control Sample after heating for 28 minutes.)
D: Overall scorching (The degree of scorching is equivalent to that of the formulation of Control Sample 2 (after heating for 30 minutes).)

TABLE 3

| | | | | Proportion of | |
|---|---|---|---|---|---|
| | | | Amount added | water added | |
| Test Sample | α-Amylase | Bacterial origin | (U/g-raw rice) | (vs. raw rice) | Heating time |
| Control Sample 1 | — | — | — | 130% | 26 min |
| Control Sample 2 | — | — | — | 130% | 30 min |
| Test Sample 1 | SPITASE CP-40F | Bacillus | 0.44 | 130% | 30 min |
| | | amyloliquefaciens | | | |
| Test Sample 2 | Biozyme A | Aspergillus oryzae | 0.10 | 130% | 30 min |
| Test Sample 3 | Kokugen SD-A | Bacillus | 0.12 | 130% | 30 min |
| | | amyloliquefaciens | | | |
| Test Sample 4 | Kokugen SD-T | Bacillus | 0.017 | 130% | 30 min |
| | | licheniformis | | | |
| Test Sample 5 | Novamyl Conc. BG | Bacillus subtilis | 0.35 | 130% | 30 min |

* Enzyme activity value (U) is the value obtained by the activity measurement method implemented by the manufacturer.

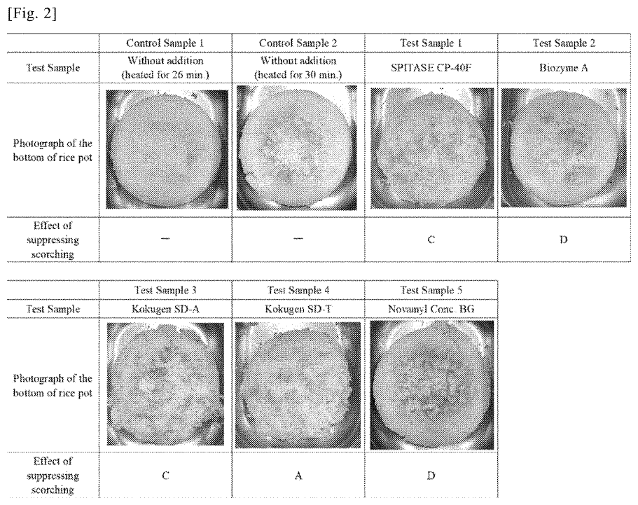

Results are shown in FIG. 2. Scorching was increased in the Control Samples (samples without the addition of α-amylase) due to extending the heating time from 26 minutes to 30 minutes. In the case of adding Bacillus licheniformis-derived α-amylase, scorching suppression was confirmed. On the other hand, in the case of adding α-amylase derived from a different organism, substantially no scorching suppression was confirmed. In Test Samples 1 and 3, as rice adhered to the bottom of the rice pot and part of the rice at the bottom was peeled off, the amount of scorched rice appeared small, while the actual degree of scorching was not much different from Control Sample 2. It was therefore evaluated as C (partial scorching).

### Example 3: Evaluation of Effect of Active Substance on Improving Cooked Rice Food Product (3)

In this Example, a cooked rice product (white rice) was produced by adding an active substance to evaluate the effect of the active substance on improving a cooked rice food product.

Rice cooking was carried out using a pot and an induction heater cooktop under the conditions shown in Table 4 to produce white rice products. The cooked white rice was stored at 20° C. for 30 hours, and then the texture was measured by sensory evaluation to evaluate the aging suppression effect. The evaluation criteria were as follows.

### <Evaluation Criteria for Aging Suppression Effect>

A: Highly effective
B: Effective
C: Slightly Effective
D: Not effective (same texture as the control)

TABLE 4

| | | | | Proportion of | |
|---|---|---|---|---|---|
| | | | Amount added | water added | |
| Test Sample | α-Amylase | Bacterial origin | (U/g-raw rice) | (vs. raw rice) | Heating time |
| Control Sample | — | — | — | 130% | 26 min |
| Test Sample | Kokugen SD-T | Bacillus | 0.017 | 130% | 30 min |
| | | licheniformis | | | |

* Enzyme activity value (U) is the value obtained by the activity measurement method implemented by the manufacturer.

Results are shown in Table 5. Aging was obviously suppressed in the test sample to which Bacillus licheniformis-derived α-amylase was added and which was heated for an extended period of time.

TABLE 5

| Test Sample | Aging suppression effect | Evaluation comments |
|---|---|---|
| Control Sample | — | Crumbly texture with |
| | | weak stickiness |
| Test Sample | A | Soft and sticky texture |

### Industrial Applicability

According to the present invention, a cooked-rice food product can be improved.

1. A composition,
which is for producing or improving a cooked-rice food product, and
which contains the following component (A):
(A) Bacillus licheniformis-derived α-amylase.

2. The composition according to claim 1, wherein the improvement is suppressing scorching and/or aging of the cooked-rice food product.

3. The composition according to claim 1, which further contains the following component (B):
(B) a glycosyltransferase.

4. The composition according to claim 3, wherein the glycosyltransferase is maltotriosyl transferase.

5. A method for producing a cooked-rice food product, comprising
a step of treating a cooked-rice food product ingredient with the following component (A):
(A) Bacillus licheniformis-derived α-amylase.

6. The method according to claim 5, wherein the produced cooked-rice food product is an improved cooked-rice food product.

7. A method for improving a cooked-rice food product, comprising
a step of treating a cooked-rice food product ingredient with the following component (A):
(A) Bacillus licheniformis-derived α-amylase.

8. The method according to claim 6, wherein the improvement is suppressing scorching and/or aging of the cooked-rice food product.

9. The method according to claim 5, wherein the treatment is performed during rice cooking.

10. The method according to claim 5, wherein the component (A) is added in an amount of from 0.001 to 10 U per 1 g of raw rice.

11. The method according to claim 5, which further comprises a step of treating the cooked-rice food product ingredient with the following component (B):
(B) a glycosyltransferase.

12. The method according to claim 11, wherein the glycosyltransferase is maltotriosyl transferase.

13. An agent for improving or producing a cooked-rice food product, which contains the following component (A):
(A) Bacillus licheniformis-derived α-amylase.

14. The agent according to claim 13, wherein the improvement is suppressing scorching and/or aging of the cooked-rice food product.

15. The agent according to claim 13, which further contains the following component (B):
(B) a glycosyltransferase.

16. The agent according to claim 15, wherein the glycosyltransferase is maltotriosyl transferase.
